(19) United States
(12) Patent Application Publication
(10) Pub. No.: US 2020/0336628 A1
(43) Pub. Date: Oct. 22, 2020

(54) CAMERA ASSEMBLY AND UNMANNED AERIAL VEHICLE

(71) Applicant: SZ DJI TECHNOLOGY CO., LTD., Shenzhen (CN)

(72) Inventors: Liang SUN, Shenzhen (CN); Xiaokai GUO, Shenzhen (CN)

(21) Appl. No.: 16/920,688

(22) Filed: Jul. 4, 2020

Related U.S. Application Data
(63) Continuation of application No. PCT/CN2018/104527, filed on Sep. 7, 2018.

(30) Foreign Application Priority Data
Jan. 5, 2018 (CN) 201820025015.7

(51) Int. Cl. H04N 5/225; B64C 39/02; B64D 47/08

(52) U.S. Cl. CPC H04N 5/2253; B64C 39/024; B64C 2201/127; H04N 5/2254; B64C 2201/027; B64D 47/08

(57) ABSTRACT

A camera assembly includes a bracket and a camera device. The bracket includes a mounting surface, which is configured to be connected to a body of an unmanned aerial vehicle (UAV). The camera device is mounted at the bracket. An optical axis of the camera device tilts downward relative to the mounting surface.

### CROSS-REFERENCE TO RELATED APPLICATIONS

This application is a continuation of International Application No. PCT/CN2018/104527, filed Sep. 7, 2018, which claims priority to Chinese Application No. 201820025015.7, filed Jan. 5, 2018, the entire contents of both of which are incorporated herein by reference.

### TECHNICAL FIELD

The present disclosure generally relates to the unmanned aerial vehicle (UAV) technology field and, more particularly, relates to a camera assembly and a UAV.

### BACKGROUND

In related technology, an unmanned aerial vehicle (UAV) is often used for aerial photography. Generally, a small aerial photography UAV only includes a downward-view camera, and the photographing angle of view is thus limited, which results in a small photographing field of view for the UAV. As such, the UAV is not suitable for photographing in some scenes, which limits application scenarios of the aerial photography of the UAV.

### SUMMARY

In accordance with the present disclosure, there is provided a camera assembly including a bracket and a camera device. The bracket includes a mounting surface, which and is configured to be connected to a body of an unmanned aerial vehicle (UAV). The camera device is mounted at the bracket. An optical axis of the camera device tilts downward relative to the mounting surface.

In accordance with the present disclosure, there is provided an unmanned aerial vehicle (UAV) including a body and a camera assembly. The camera assembly includes a bracket and a camera device. The bracket includes a mounting surface, which is configured to be connected to the body of the UAV. The camera device is mounted at the bracket. An optical axis of the camera device tilts downward relative to the mounting surface.

### BRIEF DESCRIPTION OF THE DRAWINGS

FIG. 1 illustrates a schematic three-dimensional (3D) diagram of a camera assembly according to some embodiments of the present disclosure.

FIG. 2 illustrates a schematic exploded view of a part of the camera assembly according to some embodiments of the present disclosure.

FIG. 3 illustrates a schematic side view of a bracket of the camera assembly according to some embodiments of the present disclosure.

FIG. 4 illustrates a schematic 3D diagram of a part of the camera assembly according to some embodiments of the present disclosure.

FIG. 5 illustrates a schematic 3D diagram of a light guide according to some embodiments of the present disclosure.

FIG. 6 illustrates a schematic 3D diagram of an unmanned aerial vehicle (UAV) according to some embodiments of the present disclosure.

FIG. 7 illustrates a schematic exploded view of the UAV according to some embodiments of the present disclosure.

FIG. 8 illustrates a schematic cross-sectional view of the UAV according to some embodiments of the present disclosure.

FIG. 9 illustrates a schematic enlarged view of the UAV at IX in FIG. 8 according to some embodiments of the present disclosure.

### REFERENCE NUMERALS

100 UAV
10 Camera assembly
12 racket
121 Mounting surface
122 First bracket
1222 Protrusion
1224 Cylindrical member
1225 Through-hole
123 Second bracket
1232 Snap hole
1234 Notch
124 Accommodation space
125 Gap
126 Clamp slot
127 First abutting surface
128 Mounting member
129 Bracket body
14 Camera device
142 Image sensor
144 Lens barrel
146 Circuit board
148 Connection interface
16 Light guide
162 Second abutting surface
20 Body
22 Mounting platform

### DETAILED DESCRIPTION OF THE EMBODIMENTS

Embodiments of the present disclosure are described in detail below. Examples of embodiments are shown in the drawings, in which the same or similar reference numerals indicate the same or similar elements or elements having the same or similar functions. Referring to the drawings, implementations described below are exemplary, are only used to explain embodiments of the present disclosure, and should not be considered as a limitation to embodiments of the present disclosure.

In the description of embodiments of the present disclosure, orientation or the position relationship indicated by terms “center,” “longitudinal,” “transverse,” “length,” “width,” “thickness,” “up,” “down,” “front,” “back,” “left,” “right,” “vertical,” “horizontal,” “top,” “bottom,” “inner,” “outer,” “clockwise,” “counterclockwise” is based on the orientation or position relationship shown in the drawings, only to facilitate the description of embodiments of the present disclosure and simplify the description, rather than indicating or implying that the device or element referred to must have a specific orientation and be constructed and operated in a specific orientation. Therefore, the terms should not be understood to limit embodiments of the present disclosure. In addition, the terms “first” and “second” are used for descriptive purposes only, and should not be understood to indicate or imply relative importance or implicitly indicating the number of indicated technical features. Thus, features defined as “first” and “second” may explicitly or implicitly include one or more of the features. In the description of embodiments of the present disclosure, the meaning of “plurality” is two or more, unless otherwise specified.

In the description of embodiments of the present disclosure, the terms “mount,” “connection,” and “coupling” should be understood in a broad sense. For example, the terms may indicate a fixed connection, a detachable connection, an integral connection, a mechanical connection, an electrical connection, a communication, a direct connection, an indirect connection through an intermediary, internal communication of two components, or interaction relationship of two components. Those of ordinary skill in the art should understand the specific meanings of the above terms in embodiments of the present disclosure according to specific situations.

In embodiments of the present disclosure, unless otherwise specified and defined, the first feature “above” or “below” the second feature may include the direct contact of the first and second features, or may include indirect contact of the first and second features through other feature contacts therebetween. Moreover, the first feature being “above,” “on,” and “over” the second feature includes that the first feature is directly above or obliquely above the second feature, or simply means that the first feature is higher in level than the second feature. The first feature being “below,” “under,” and “beneath” the second feature includes that the first feature is directly under or obliquely under the second feature, or simply means that the first feature is lower in height than the second feature.

The present disclosure provides many various implementations or examples to implement different structures of embodiments of the present disclosure. To simplify embodiments of the present disclosure, components, and settings of specific examples are described below. The description is merely exemplary and does not intend to limit embodiments of the present disclosure. Reference numerals and/or letters are repeated in different examples in embodiments of the present disclosure for simplicity and clarity, and does not indicate relationship among various implementations and/or settings. Embodiments of the present disclosure provide examples of various specific processes and materials, but those of ordinary skill in the art may be aware of application of other processes and/or use of other materials.

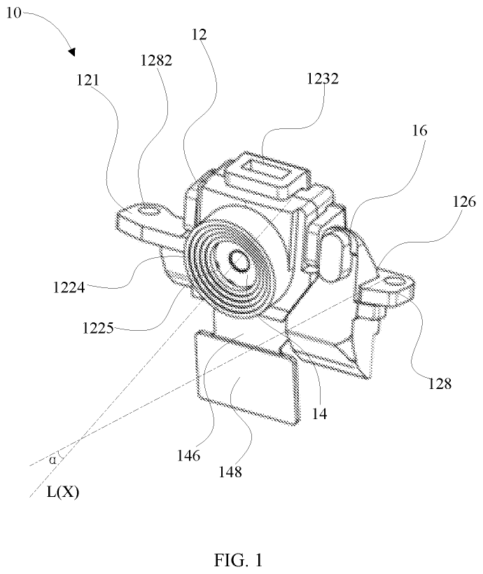

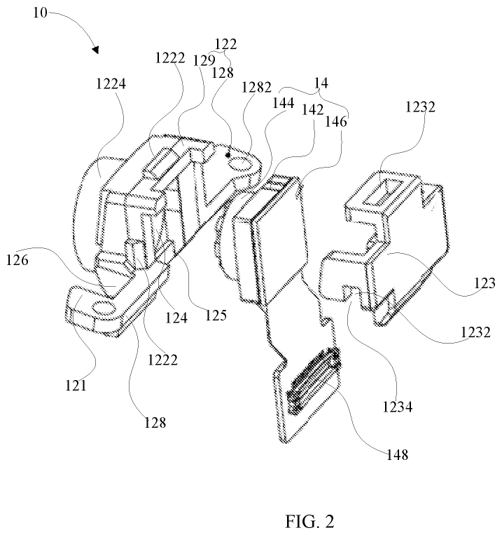

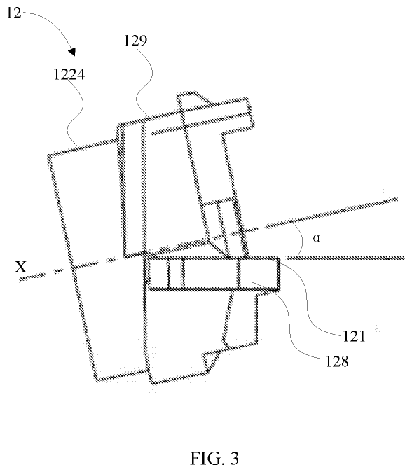

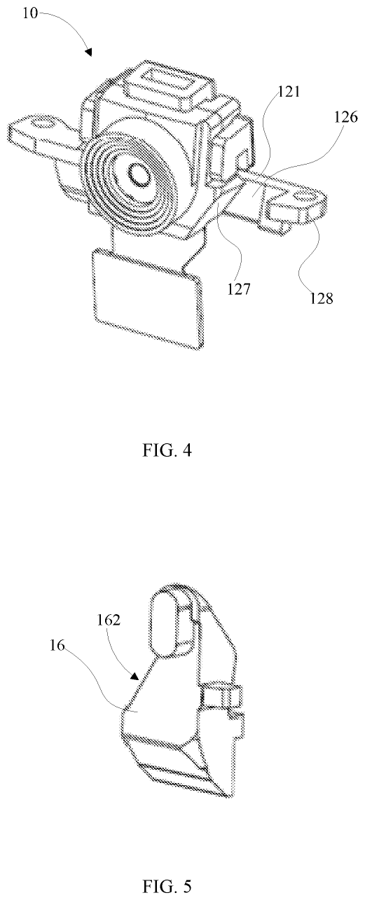

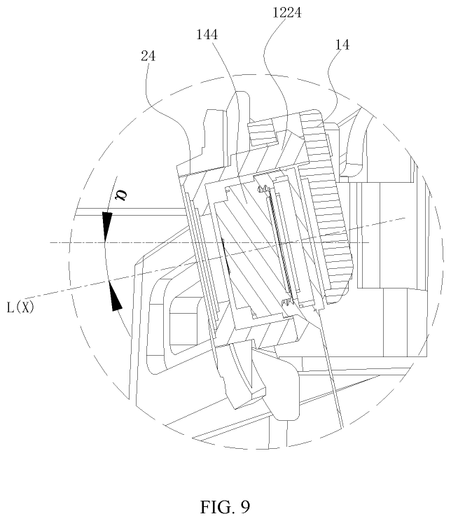

As shown in FIGS. 1-4, 8, and 9, a camera assembly 10 of embodiments of the present disclosure is applied to an unmanned aerial vehicle (UAV) 100. The camera assembly 10 includes a bracket 12 and a camera device 14. The camera device 14 is mounted at the bracket 12. The bracket 12 includes a mounting surface 121 connected to a body 20 of the UAV 100, and an optical axis L of the camera device 14 inclined downward relative to the mounting surface 121.

In embodiments of the present disclosure, when the camera assembly 10 is applied to the UAV 100, the mounting surface 121 may be horizontally mounted at the body 20 of the UAV 100. As such, the camera device 14 may conveniently photograph scenes in front of or in an obliquely downward direction of the UAV 100, and thus the photographing angle of view of the camera assembly 10 can be enlarged. Therefore, application scenarios of the aerial photography of the UAV 100 are expanded.

In some embodiments, an angle α between the optical axis L of the camera device 14 and the horizontal direction is an acute angle α. Thus, the camera device 14 has a better photographing angle of view and may photograph the scenes in the obliquely downward direction of the UAV 100.

In some embodiments, the UAV 100 is provided with a downward-view camera. The angle α of the optical axis L of the camera device 14 relative to the horizontal direction is an acute angle, which may prevent the photographing angle of view of the camera device 14 from overlapping with a photographing angle of view of the downward-view camera.

In some embodiments, the acute angle α is 10°-4°. Thus, the camera device 14 has a better photographing angle of view. In some embodiments, the acute angle α is 12°. In some other embodiments, the acute angle α is not limited to 12°. For example, the acute angle α may be 10° , 14°, or any other degree between 10° and 14°.

In some embodiments, the bracket 12 includes a first bracket 122 and a second bracket 123 detachably connected to each other. The first bracket 122 and the second bracket 123 are connected to form an accommodation space 124. The camera device 14 includes an image sensor 142. The image sensor 142 is accommodated in the accommodation space 124.

As such, the camera device 14 may be detached from the bracket 12, which makes it convenient to repair and replace the camera device 14, extending application lifetime of the camera assembly 10 and improving user experience. The image sensor 142 is better protected when being accommodated in the accommodation space 124.

In some embodiments, a dimension and a shape of the accommodation space 124 correspond to a dimension and a shape of the image sensor 142. Thus, the image sensor 142 may be stably mounted in the accommodation space 124, such that the camera assembly 10 has a stable structure. When the camera assembly 10 is applied to the UAV 100 for aerial photography, the aerial photography effect may also be improved.

In some embodiments, the first bracket 122 is provided with an accommodation slot. The accommodation space 124 is formed at the accommodation slot. During assembly, the camera device 14 may be arranged in the accommodation space 124 first, then the second bracket 123 is connected to the first bracket 122 to fix the camera device 14 in the accommodation space 124. Thus, the assembly process of the camera assembly 10 is simpler and faster. In some other embodiments, two accommodation slots may be provided oppositely at the first bracket 122 and the second bracket 123, respectively, to form the accommodation space 124.

In some embodiments, the first bracket 122 and the second bracket 123 are connected through a snap connection. As such, the assembly of the first bracket 122 and the second bracket 123 is convenient and quick, which may improve assembly speed of the camera assembly 10 to improve efficiency.

In some embodiments, an outer surface of the first bracket 122 is provided with a protrusion 1222. The second bracket 123 is provided with a snap hole 1232 corresponding to the protrusion 1222. By snapping the protrusion 1222 in the snap hole 1232, the first bracket 122 and the second bracket 123 are connected through the snap connection. In some embodiments, each of a top surface and two side surfaces of the first bracket 122 is provided with one protrusion 1222. Each of a top and two sides of the second bracket 123 is provided with one snap hole 1232 corresponding to the protrusion 1222. A notch 1234 is formed at bottom of each of the snap holes 1232 at two sides. The protrusion 1222 is snapped into the snap hole 1232 through the notch 1234. When the first bracket 122 and the second bracket 123 is assembled in this way, the second bracket 123 may be moved from the top to bottom toward the first bracket 122 to cause the protrusion 1222 at the top and the protrusions 1222 at two side surfaces to snap into the corresponding snap holes 1232. As such, the first bracket 122 and the second bracket 123 are connected through the snap connection, and the assembly is convenient and quick.

In some other embodiments, the connection manner between the first bracket 122 and the second bracket 123 is not limited to the snap connection and may include other connection manners, such as a bolt connection, a rivet connection, etc.

In some embodiments, the first bracket 122 includes a cylindrical member 1224. The cylindrical member 1224 is provided with a through-hole 1225. The camera device 14 includes a lens barrel 144. The lens barrel 144 is accommodated in the through-hole 1225. The axis X of the through-hole 1225 coincides with the optical axis L of the camera device 14. As such, an orientation of the lens barrel 144, and hence an orientation of the camera device 14, may be determined by an orientation of the through-hole 1225, and an obliquely downward angle of the camera device 14 is ensured to be accurate.

In some embodiments, the lens barrel 144 is provided with a lens set. The image sensor 142 is arranged at an image side of the lens set. The through-hole 1225 communicates with the accommodation space 124. During assembly, the lens barrel 144 may be inserted into the through-hole 1225, and the image sensor 142 is arranged in the accommodation space 124, then the second bracket 123 is mounted at the first bracket 122. As such, the angle of the camera device 14 may be fixed through the through-hole 1225, the angle of the camera device 14 may not need to be adjusted, and the assembly is convenient and quick.

In some other embodiments, the axis X of the through-hole 1225 may be parallel to the optical axis L of the camera device 14.

In some embodiments, a gap 125 is formed at the connection between the first bracket 122 and the second bracket 123. The camera device 14 includes a circuit board 146. The image sensor 142 is arranged at the circuit board 146. A portion of the circuit board 146 penetrates the gap 125 and extends out of the bracket 12. As such, the circuit board 146 extends out of the bracket 12 through the gap 125 and is connected to an external circuit to transmit image information obtained by the image sensor 142 to the external circuit.

In some embodiments, the gap 125 communicates with the accommodation space 124 and is arranged at the bottom of the accommodation space 124. Thus, the circuit board 146 hangs down due to gravity and extends out from the gap 125, which is convenient for assembly.

Further, the circuit board 146 may include a flexible printed circuit (FPC). The FPC includes characteristics of high wire density, lightweight, thin thickness, and good bendability. Thus, the circuit board 146 may be bendable, and the assembly of the camera assembly 10 is more convenient.

In some embodiments, a connection interface 148 is arranged at the portion of the circuit board 146 outside the bracket 12. As such, the circuit board 146 is conveniently connected to the external circuit to transmit the image information obtained by the image sensor 142 to the external circuit.

As shown in FIG. 5, in some embodiments, the camera assembly 10 includes a light guide 16. The light guide 16 is mounted at the bracket 12. As such, the light guide 16 may provide compensation light for the camera device 14 or send out a prompt signal.

In some embodiments, the camera assembly 10 includes a light source (not shown in the figure). The light guide 16 can use total reflection to guide light emitted by the light source to the front and lower position of the camera device 14 to achieve a good light guide effect. When light is weak, the light guide may provide compensation light to ensure that the camera device 14 photograph an image with better quality. When the UAV 100 needs to send the prompt signal, the light source emits light, and the light is emitted by the light guide as the prompt signal. The light emitted by the light source may include a plurality of colors. Different colors or color combinations may correspond to different prompt signals.

In some embodiments, the bracket 12 is provided with a clamp slot 126. The light guide 16 is clamped at the clamp slot 126. The clamp slot 126 includes a tilted first abutting surface 127. A side surface of the light guide 16 is a tilted second abutting surface 162. The first abutting surface 127 abuts against the second abutting surface 162 to facilitate the light guide 16 to be mounted at the bracket 12.

In some embodiments, as shown in FIG. 5, the clamp slot 126 is arranged at the first bracket 122 and close to the cylindrical member 1224. As such, the light guide 16 may provide better light compensation for the camera device 14.

In some embodiments, two mounting members 128 are formed at two sides of the bracket 12. Mounting surfaces 121 are formed at top surfaces of the two mounting members 128. As such, the bracket 12 is mounted at the body 20 of the UAV 100 through the two mounting members 128, such that the mounting surfaces 121 may be horizontally mounted at the body 20 of the UAV 100 to cause the camera device 14 to photograph the scenes in front and obliquely downward of the UAV 100.

In some embodiments, the first bracket 122 includes a bracket body 129 and the two mounting members 128 arranged at both sides of the bracket body 129. A clamp slot 126 is arranged at one of the mounting members 128. The protrusion 1222 is arranged at the outer surface of the bracket body 129. A mounting hole 1282 is arranged at each of the mounting members 128. When the bracket 12 is mounted at the body 20 of the UAV 100, the body 20 of the UAV 100 is provided with a mounting platform 22. The top surface of the mounting member 128 abuts against the mounting platform 22. The mounting member 128 is fixed at the mounting platform 22 by arranging a fastener component 1284 through the mounting hole 1282. As such, the second bracket 123 is fixedly mounted at the first bracket 122, the first bracket is fixedly mounted at the mounting platform 22, and the camera device 14 is mounted in the accommodation space 124 to stably mount the camera assembly 10 at the body 20. The assembly process is convenient and quick. An angle of the mounting platform 22 is fixed relative to the body 20 of the UAV 100, such that the angle of the optical axis L of the camera device 14 is fixed relative to the body 20 of the UAV 100.

In some other embodiments, the camera assembly 10 may also be mounted at the body 20 of the UAV 100 through another mounting manner, such as welding or snap connection.

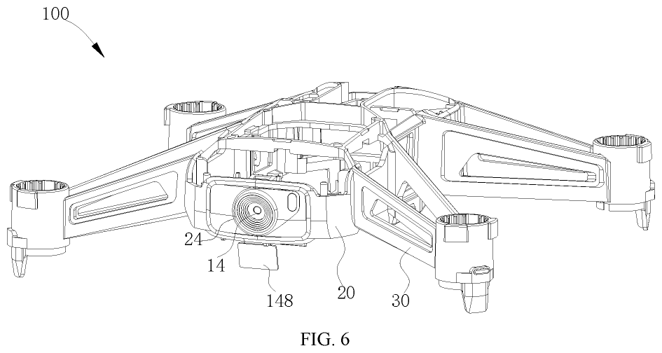

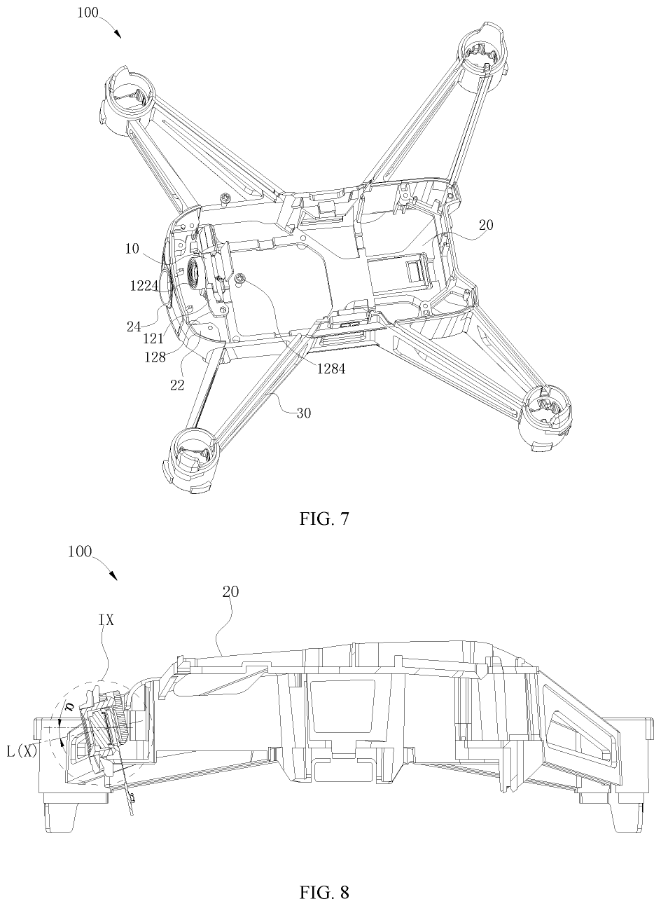

As shown in FIGS. 6-9, the UAV 100 of embodiments of the present disclosure includes the body 20 and the camera assembly 10 of any above embodiments. The bracket 12 is mounted at the body 20 through the mounting surface 121.

In embodiments of the present disclosure, the mounting surface 121 may be horizontally mounted at the body 20 of the UAV 100. As such, the camera device 14 may photograph the scenes in front and obliquely downward of the UAV 100, the photography is convenient, the photographing angle of view of the camera assembly 10 is enlarged, such that the application scenarios of the aerial photography of the UAV 100 is expanded.

In some embodiments, a body-through-hole 24 is arranged at front of the body 20 corresponding to the cylindrical member 1224. The cylindrical member 1224 is arranged through the body-through-hole 24. As such, at one aspect, the camera assembly 10 can be mounted more stably, and at another aspect, the photographing angle of view of the camera device 14 is larger.

The UAV 100 includes arms 30 arranged at the body 20 and power assemblies (not shown in the figure) arranged at the arms 30. The power assemblies provide power for a flight of the UAV 100.

In some embodiments, the UAV 100 includes the downward-view camera (not shown in the figure). The downward-view camera is mounted at the bottom of the body 20. The camera assembly 10 is mounted at the front of the body 20. As such, the camera assembly 10 cooperates with the downward-view camera to enlarge the photographing angle of view of the UAV 100 and achieve a better aerial photography effect.

In the description of this specification, referring to the terms “certain embodiments,” “one embodiment,” “some embodiments,” “exemplary embodiments,” “examples,” “specific examples,” or “some examples,” the description means that specific features, structures, materials, or characteristics described in connection with embodiments or examples are included in at least one embodiment or example of the present disclosure. In this specification, the schematic description of the above terms does not necessarily refer to a same embodiment or example. The described specific features, structures, materials, or characteristics may be combined in any suitable manner in any one or more embodiments or examples.

Although embodiments of the present disclosure are shown and described above, above-described embodiments are exemplary and should not be considered as a limitation to the present disclosure. Those of ordinary skill in the art can perform change, modification, replacement, and transformation on above-described embodiments. The scope of the invention is defined by the claims and their equivalents.

What is claimed is:

1. A camera assembly comprising:
a bracket including a mounting surface configured to be connected to a body of an unmanned aerial vehicle (UAV); and
a camera device mounted at the bracket, an optical axis of the camera device tilting downward relative to the mounting surface.

2. The camera assembly of claim 1, wherein an angle between the optical axis of the camera device and a horizontal direction is an acute angle.

3. The camera assembly of claim 2, wherein the acute angle is in a range of 10°-14°.

4. The camera assembly of claim 1, wherein:
the bracket includes a first bracket and a second bracket detachably connected to form an accommodation space; and
the camera device includes an image sensor accommodated in the accommodation space.

5. The camera assembly of claim 4, wherein the first bracket and the second bracket are connected through a snap connection.

6. The camera assembly of claim 4, wherein:
the first bracket includes a cylindrical member, the cylindrical member including a through-hole, an axis direction of the through-hole being parallel to the optical axis of the camera device or coinciding with the optical axis of the camera device; and
the camera device includes a lens barrel accommodated in the through-hole.

7. The camera assembly of claim 4, wherein:
the camera device includes a circuit board, a portion of the circuit board extend out of the bracket through a gap between the first bracket and the second bracket; and
the image sensor is arranged at the circuit board.

8. The camera assembly of claim 7, wherein the circuit board includes a connection interface at the portion of the circuit board outside the bracket.

9. The camera assembly of claim 1, further comprising:
a light guide mounted at the bracket.

10. The camera assembly of claim 9, wherein:
the bracket includes a clamp slot, the clamp slot including a tilted first abutting surface;
the light guide includes a tiled second abutting surface; and
the first abutting surface abuts against the second abutting surface.

11. The camera assembly of claim 1, wherein:
the bracket further includes two mounting members formed at two sides of the bracket;
the mounting surface is a first mounting surface formed at a top surface of one of the two mounting members; and
a top surface of another one of the two mounting members forms a second mounting surface configured to be connected to the body of the UAV.

12. An unmanned aerial vehicle (UAV) comprising:
a body; and
a camera assembly including:
a bracket including a mounting surface configured to be connected to the body; and
a camera device mounted at the bracket, an optical axis of the camera device tilting downward relative to the mounting surface.

13. The UAV of claim 12, wherein an angle between the optical axis of the camera device and a horizontal direction is an acute angle.

14. The UAV of claim 13, wherein the acute angle is in a range of 10°-14°.

15. The UAV of claim 12, wherein:
the bracket includes a first bracket and a second bracket detachably connected to form an accommodation space; and
the camera device includes an image sensor accommodated in the accommodation space.

16. The UAV of claim 15, wherein the first bracket and the second bracket are connected through a snap connection.

17. The UAV of claim 15, wherein:
the first bracket includes a cylindrical member, the cylindrical member being including a through-hole, an axis direction of the through-hole being parallel to the optical axis of the camera device or coinciding with the optical axis of the camera device; and
the camera device includes a lens barrel accommodated in the through-hole.

18. The UAV of claim 15, wherein:
the camera device includes a circuit board, a portion of the circuit board extend out of the bracket through a gap between the first bracket and the second bracket; and
the image sensor is arranged at the circuit board.

19. The UAV of claim 18, wherein the circuit board includes a connection interface at the portion of the circuit board outside the bracket.

20. The UAV of claim 12, wherein the camera assembly includes a light guide mounted at the bracket.
